(19) United States
(12) Patent Application Publication
(10) Pub. No.: US 2023/0199304 A1
(43) Pub. Date: Jun. 22, 2023

(54) INFORMATION PROCESSING APPARATUS, INFORMATION PROCESSING METHOD, IMAGING APPARATUS, CONTROL METHOD, AND STORAGE MEDIUM

(71) Applicant: CANON KABUSHIKI KAISHA, Tokyo (JP)

(72) Inventor: Chiaki Kamei, Tokyo (JP)

(21) Appl. No.: 18/065,554

(22) Filed: Dec. 13, 2022

(30) Foreign Application Priority Data
Dec. 20, 2021 (JP) 2021-206194

(51) Int. Cl. H04N 23/661; H04N 23/62; H04N 7/18

(52) U.S. Cl. CPC H04N 23/661; H04N 23/62; H04N 7/183

(57) ABSTRACT

An information processing apparatus acquires an image transmitted from an imaging apparatus, causes a display to display setting menus of a plurality of setting processes of different types and the image, and identifies, in a case where a certain setting menu is selected from among the setting menus of the plurality of setting processes, an image setting corresponding to the certain setting menu based on respective image settings associated with the setting menus of the plurality of setting processes, wherein a control command to cause an image setting of the imaging apparatus to match the identified image setting is generated and the control command is transmitted to the imaging apparatus.

### BACKGROUND

### Field of the Disclosure

The present disclosure relates to an information processing method.

### Description of the Related Art

A conventional imaging apparatus that captures an image has the function of distributing an image (hereinafter, a “clipped image”) obtained by clipping a partial area within the angle of view from an image of the entire angle of view to an information processing apparatus. According to a conventional art, the information processing apparatus can display an image or a clipped image received from the imaging apparatus on a display. The information processing apparatus that receives an image from the imaging apparatus has the function of changing the settings of the imaging apparatus according to a user input made via a setting screen displayed on the display. With this function, the user can change parameters regarding the settings of the imaging apparatus while confirming an image distributed from the imaging apparatus and displayed by the information processing apparatus.

Japanese Patent Application Laid-Open No. 2016-36183 discusses a method for making settings while viewing a video in which a clipping range changes according to the position of the focus.

In a case where there is a plurality of setting processes of different types as a setting process regarding an image captured by an imaging apparatus, a suitable image as an image to be displayed according to the setting process may exist. A case is assumed where a user makes settings regarding a certain setting process on a setting screen. At this time, in Japanese Patent Application Laid-Open No. 2016-36183, a suitable image as a display target in the setting process is not considered. Thus, the user needs to manually perform an operation for displaying the suitable image, which is troublesome.

### SUMMARY

To prevent an operation for displaying an image suitable for a setting process to be performed on a setting screen from being troublesome, an information processing apparatus according to embodiments of the present disclosure has the following configuration. That is, embodiments of the present disclosure include an information processing apparatus comprising a computer executing instructions which, when executed by the computer, cause the information processing apparatus to: acquire an image transmitted from an imaging apparatus; cause a display to display the image and setting menus of a plurality of setting processes of different types; and identify, in a case where a certain setting menu is selected from among the setting menus of the plurality of setting processes, an image setting corresponding to the certain setting menu based on respective image settings associated with the setting menus of the plurality of setting processes, wherein a control command to cause an image setting of the imaging apparatus to match the identified image setting is generated and the control command is transmitted to the imaging apparatus.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a system.

FIG. 2 is a diagram illustrating an external appearance of an imaging apparatus.

FIG. 3 is a diagram illustrating functional blocks of the imaging apparatus and an information processing apparatus.

FIGS. 4A to 4C are diagrams illustrating setting screens.

FIG. 5 is a diagram illustrating an image setting file.

FIG. 6 is a flowchart illustrating a flow of information processing regarding a setting screen.

FIG. 7 is a flowchart illustrating a flow of processing based on a control method for controlling the imaging apparatus regarding a setting screen.

FIG. 8 is a diagram illustrating a hardware configuration of each apparatus.

### DESCRIPTION OF THE EMBODIMENTS

With reference to the attached drawings, exemplary embodiments according to the present disclosure will be described below. The configurations illustrated in the following exemplary embodiments are merely examples, and are not limited to the configurations illustrated in the figures.

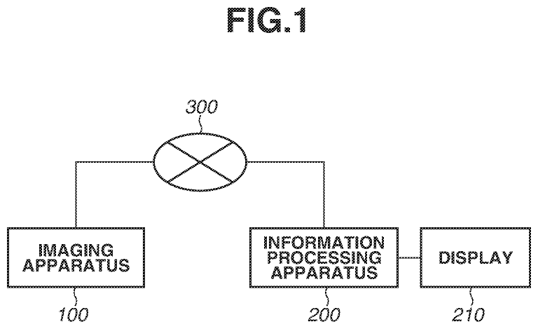

FIG. 1 is a diagram illustrating the configuration of a system according to a first exemplary embodiment. The system according to the present exemplary embodiment includes an imaging apparatus 100, an information processing apparatus 200, a display 210, and a network 300.

The imaging apparatus 100 and the information processing apparatus 200 are connected to each other via the network 300. The network 300 is achieved by a plurality of routers, switches, and cables compliant with a communication standard such as Ethernet®.

The network 300 may be achieved by the Internet, a wired local area network (LAN), a wireless LAN, or a wide area network (WAN).

The imaging apparatus 100 is an apparatus that captures an image, and functions as an image capturing unit capable of changing its image capturing range. The imaging apparatus 100 transmits image data on the captured image, information regarding the image capturing date and time when the image is captured, identification information identifying the imaging apparatus 100, and information regarding the image capturing range of the imaging apparatus 100 to an external apparatus such as the information processing apparatus 200 via the network 300. The information processing apparatus 200 is, for example, a client apparatus such as a personal computer on which a program for achieving the functions of image processing described below is installed. The system according to the present exemplary embodiment includes a single imaging apparatus 100, but may include a plurality of imaging apparatuses 100. That is, a plurality of imaging apparatuses 100 may be connected to the information processing apparatus 200 via the network 300. In this case, for example, using identification information associated with a transmitted image, the information processing apparatus 200 determines which of the plurality of imaging apparatuses 100 has captured the transmitted image.

The display 210 is composed of a liquid crystal display (LCD) and displays the image captured by the imaging apparatus 100. The display 210 is connected to the information processing apparatus 200 via a display cable compliant with a communication standard such as High-Definition Multimedia Interface (HDMI®). The display 210 and the information processing apparatus 200 may be provided in a single housing.

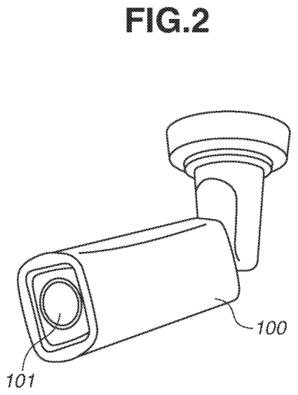

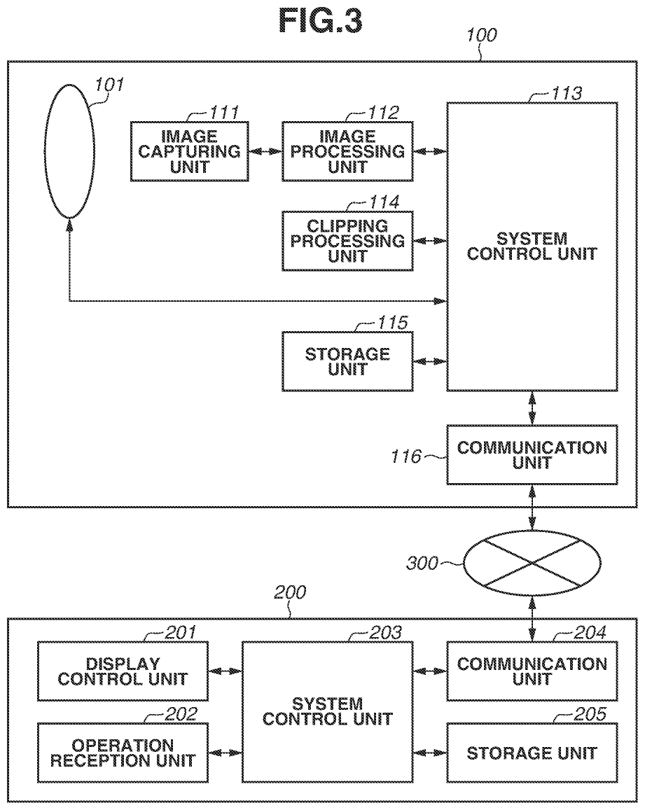

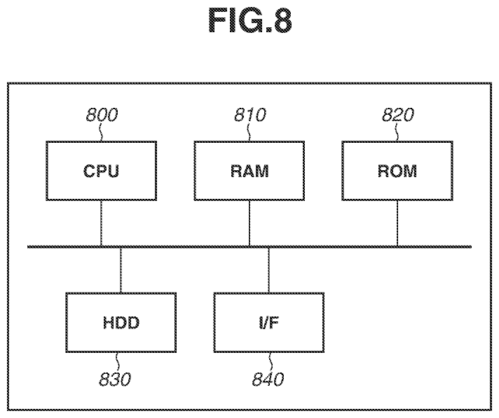

Next, with reference to FIGS. 2 and 3, the imaging apparatus 100 according to the present exemplary embodiment is described. FIG. 2 is a diagram illustrating an example of an external view of the imaging apparatus 100 according to the present exemplary embodiment. FIG. 3 is a diagram illustrating examples of the functional blocks of the imaging apparatus 100 and the information processing apparatus 200 according to the present exemplary embodiment. In the functional blocks of the imaging apparatus 100 illustrated in FIG. 3, the functions of an image processing unit 112, a system control unit 113, a clipping processing unit 114, a storage unit 115, and a communication unit 116 are achieved as follows. That is, these functions are achieved by a central processing unit (CPU) 800 of the imaging apparatus 100, described below with reference to FIG. 8, executing a computer program stored in a read-only memory (ROM) 820 of the imaging apparatus 100 described below with reference to FIG. 8.

The direction in which the optical axis of a lens 101 is directed is the image capturing direction of the imaging apparatus 100. A light beam having passed through the lens 101 forms an image on an image sensor of an image capturing unit 111 of the imaging apparatus 100. The image capturing unit 111 includes an image sensor (not illustrated) such as a charge-coupled device (CCD) sensor or a complementary metal-oxide-semiconductor (CMOS) sensor. Then, the image capturing unit 111 photoelectrically converts an object image formed through the lens 101 to generate an electric signal. The image processing unit 112 performs image processing such as the process of converting the electric signal obtained through the photoelectric conversion by the image capturing unit 111 into a digital signal, and a compression coding process, thereby generating image data on the captured image.

The clipping processing unit 114 executes a clipping process for clipping a partial area from the image of the image data generated by the image processing unit 112 (i.e., the image captured by the imaging apparatus 100), thereby generating a clipped partial image (hereinafter, a “clipped image”). For example, the clipping processing unit 114 generates the clipped image by performing the process of clipping any area of the image of the image data generated by the image processing unit 112 (electronic pan, tilt, and zoom (PTZ)) as the clipping process. The clipping processing unit 114 may also execute the following process as the clipping process. That is, the clipping processing unit 114 may generate the clipped image by determining a range to be clipped (hereinafter, a “clipping range”) so that the center position of the image captured by the imaging apparatus 100 and the center position of the clipping range match each other, and clipping the clipping range from the image. At this time, the clipping processing unit 114 performs electronic zoom as the process of matching the center position of the captured image and the center position of the clipping range while changing the size of the clipping range. This electronic zoom process results in control for virtually changing the zoom magnification.

For example, the storage unit 115 stores (holds) information indicating the position of the clipping range clipped from the captured image in the clipping process. The communication unit 116 communicates with the information processing apparatus 200 via an interface (I/F) 840 described below with reference to FIG. 8. For example, the communication unit 116 transmits the image data on the image captured by the imaging apparatus 100 to the information processing apparatus 200 via the network 300. The communication unit 116 also receives a control command that is a command to control the imaging apparatus 100 that is transmitted from the information processing apparatus 200. Then, the communication unit 116 transmits the control command to the system control unit 113. The communication unit 116 also transmits a user interface (UI) for displaying and changing the current setting value of the imaging apparatus 100 to the information processing apparatus 200.

According to processing executed by the CPU 800 described below with reference to FIG. 8, the system control unit 113 controls the entirety of the imaging apparatus 100 and performs the following process, for example. That is, the system control unit 113 analyzes the control command to control the imaging apparatus 100 that is transmitted from the information processing apparatus 200. Then, the system control unit 113 performs processing according to the control command. The system control unit 113 also indicates a clipping range to the clipping processing unit 114. The system control unit 113 also transmits the image data generated by the image processing unit 112 and data on the clipped image generated by the clipping processing unit 114 to the information processing apparatus 200.

Next, with reference to the functional blocks of the information processing apparatus 200 according to the present exemplary embodiment illustrated in FIG. 3, image processing performed by the information processing apparatus 200 according to the present exemplary embodiment is described. The functions of the information processing apparatus 200 are achieved as follows using the ROM 820 and the CPU 800 described below with reference to FIG. 8. That is, the functions illustrated in FIG. 3 are achieved by the CPU 800 of the information processing apparatus 200 executing a computer program stored in the ROM 820 of the information processing apparatus 200.

A display control unit 201 displays a setting screen regarding an image captured by the imaging apparatus 100 or image quality, and an image received from the imaging apparatus 100 on the display 210. An operation reception unit 202 receives information regarding an operation performed by a user using an input device (not illustrated) such as a keyboard, a mouse, and a touch panel. As an input unit, a button, a mouse, and a joystick are assumed, and the input unit receives various operations of the user. For example, the display control unit 201 displays a setting screen for making a setting regarding the imaging apparatus 100 on the display 210. The operation reception unit 202 receives information regarding a user operation performed on the setting screen displayed on the display 210. A system control unit 203 transmits a control command to a remote camera via a communication unit 204 according to an operation of the user.

The communication unit 204 transmits various setting commands and a control command to control the imaging apparatus 100 that are transmitted from the system control unit 203 to the imaging apparatus 100 via the OF 840 described below with reference to FIG. 8. The communication unit 204 receives image data transmitted from the imaging apparatus 100 and a response from the imaging apparatus 100 to a command transmitted from the information processing apparatus 200 to the imaging apparatus 100 and transmits the image data and the response to the system control unit 203. A storage unit 205 stores a setting screen and an image acquired by the communication unit 204.

The system control unit 203 generates various setting commands and a control command based on user operations received by the operation reception unit 202 and transmits the various setting commands and the control command to the imaging apparatus 100 via the communication unit 204.

As described above, the information processing apparatus 200 can control the imaging apparatus 100 via the network 300.

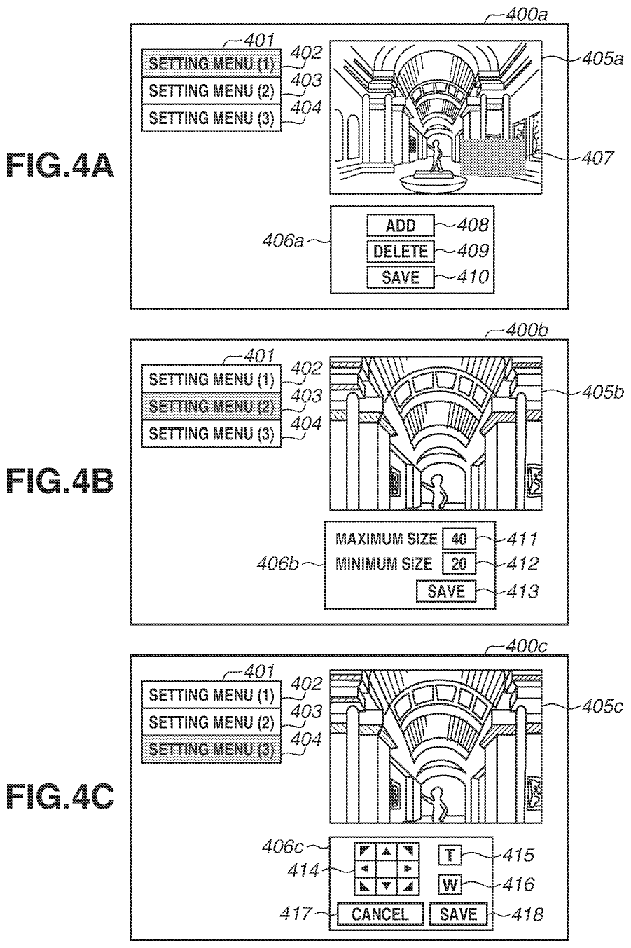

Next, with reference to graphical user interfaces (GUIs) as setting screens illustrated in FIGS. 4A to 4C, setting screens displayed on the display 210 of the information processing apparatus 200 according to the present exemplary embodiment are described. Setting screens 400a to 400c illustrated in FIGS. 4A to 4C are GUIs displayed on the display 210 by the information processing apparatus 200. As illustrated in FIGS. 4A to 4C, the setting screens 400a to 400c include a menu list 401 including a “setting menu (1)” 402, a “setting menu (2)” 403, and a “setting menu (3)” 404. As illustrated in FIGS. 4A to 4C, the setting screens 400a to 400c further include image display areas 405a to 405c where images transmitted from the imaging apparatus 100 are displayed, and setting areas 406a to 406c, respectively. The “setting menu (1)” 402, the “setting menu (2)” 403, and the “setting menu (3)” 404 in the menu list 401 are associated with respectively different setting processes. For example, the “setting menu (1)” 402 is associated with a setting process for setting a privacy mask on a captured image, and according to a user operation for selecting the “setting menu (1)” 402, the setting screen 400a for the setting process for setting a privacy mask is displayed. The setting screen 400a in FIG. 4A illustrates a setting screen to be displayed in a case where the “setting menu (1)” 402 is selected. For example, the “setting menu (2)” 403 is associated with a setting process regarding a video analysis process such as person detection or moving body detection, and according to a user operation for selecting the “setting menu (2)” 403, the setting screen 400b for the setting process regarding the video analysis process is displayed. The setting screen 400b in FIG. 4B illustrates a setting screen to be displayed in a case where the “setting menu (2)” 403 is selected. For example, the “setting menu (3)” 404 is associated with a setting process for setting a clipping range, and according to a user operation for selecting the “setting menu (3)” 404, the setting screen 400c for the setting process for setting a clipping range is displayed.

For each of the setting processes, there is a suitable setting as the setting of an image to be displayed in the image display area 405a, 405b, or 405c. For example, in a case where a privacy mask is set, there is a demand for setting an area where privacy is protected (i.e., an area where the privacy mask is set) while confirming an environment to be captured from a higher point of view. Thus, it is desirable that in the image display area 405a on the setting screen 400a corresponding to the setting of a privacy mask, an image captured at the maximum angle of view of the imaging apparatus 100 (in other words, with the zoom magnification at the wide-angle end) be displayed.

A case is considered where the setting of the video analysis process is made. Generally, in a case where the imaging apparatus 100 executes the video analysis process such as person detection or moving body detection, the video analysis process may be executed not on an image captured by the imaging apparatus 100, but on a clipped image obtained by clipping a clipping range on the image. This is because if an image to be transmitted from the imaging apparatus 100 to a certain client apparatus is a clipped image, a processing load related to the video analysis process is smaller in a case where the video analysis process is executed on the clipped image, which is a partial image of the image captured by the imaging apparatus 100, than in a case where the video analysis process is executed on the entirety of the image. Accordingly, a case is assumed where the setting of the video analysis process is made, and the video analysis process is executed on a clipped image generated by the imaging apparatus 100. At this time, it is desirable that the clipped image be displayed in the image display area 405b on the setting screen 400b corresponding to the setting of the video analysis process. The clipped image in this case may be an image in a clipping range subjected to electronic PTZ by the imaging apparatus 100, or may be an image in a clipping range subjected to electronic zoom.

In the case of the setting process for setting a clipping range, it is desirable that an image in a clipping range be displayed to enable the user to appropriately confirm, for example, how a clipped image clipped from an image captured by the imaging apparatus 100 actually appears. Thus, in the image display area 405c on the setting screen 400c corresponding to the setting process for setting a clipping range, a clipped image generated by clipping a clipping range set in an image captured by the imaging apparatus 100 and transmitted to the information processing apparatus 200 is displayed.

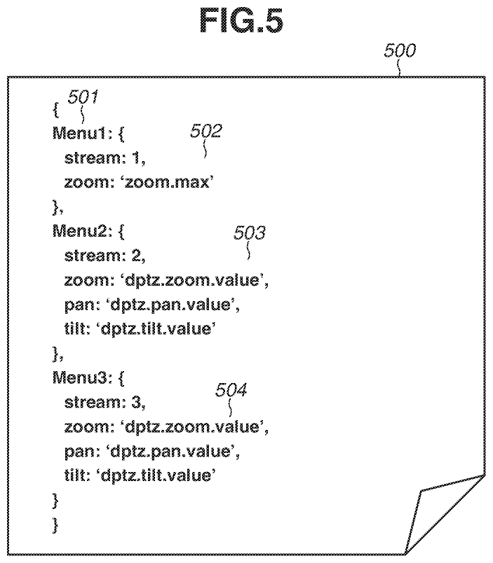

As described above, for each of the setting screens, there is a suitable setting (hereinafter, an “optimal image setting”) as the setting of an image to be displayed. With reference to FIG. 5, the optimal image setting associated with each of the setting screens is described. A setting file 500 illustrated in FIG. 5 includes information regarding the optimal image setting of an image to be displayed on the setting screen corresponding to each of the setting menus. The setting file 500 may be held in advance in the information processing apparatus 200, or may be held in the imaging apparatus 100 and appropriately acquired from the imaging apparatus 100 by the information processing apparatus 200. As illustrated in FIG. 5, the setting file 500 includes menu names 501 (“Menu1” to “Menu3”) identifying the respective setting menus and information regarding the optimal image settings of the respective menu names 501. For example, an optimal image setting 502 of “Menu1” corresponding to the setting screen 400a includes information ‘1’ identifying the stream of image data transmitted from the imaging apparatus 100 and information ‘zoom.max’ indicating the maximum angle of view. That is, this indicates that it is desirable that in “Menu1” (the setting screen 400a), an image transmitted on a stream ‘1’ from the imaging apparatus 100 and captured at the maximum angle of view of the imaging apparatus 100 be displayed.

Similarly, an optimal image setting 503 of “Menu2” corresponding to the setting screen 400b includes information ‘2’ identifying the stream of image data transmitted from the imaging apparatus 100 and information ‘dptz.zoom.value’, ‘dptz.pan.value’, and ‘dptz.tilt.value’ indicating a clipping range. That is, this indicates that it is desirable that in “Menu2” (the setting screen 400b), an image that is transmitted on a stream ‘2’ from the imaging apparatus 100 and is a clipped image in a clipping range currently set in the imaging apparatus 100 be displayed. Similarly, an optimal image setting 504 of “Menu3” corresponding to the setting screen 400c includes information ‘3’ identifying the stream of image data transmitted from the imaging apparatus 100 and information ‘dptz.zoom.value’, ‘dptz.pan.value’, and ‘dptz.tilt.value’ indicating a clipping range. That is, this indicates that it is desirable that in “Menu3” (the setting screen 400c), an image that is transmitted on a stream ‘3’ from the imaging apparatus 100 and is a clipped image in a clipping range currently set in the imaging apparatus 100 be displayed.

The format of the setting file 500 including the optimal image settings associated with the setting screens (or the setting menus) is not limited to the example illustrated in FIG. 5. For example, the setting file 500 may be represented by text display, the Extensible Markup Language (XML), the HyperText Markup Language (HTML), or the JavaScript Object Notation (JSON), or in an object format or a binary format. The settings of the optimal image settings 502 to 504 are not limited to the examples illustrated in FIG. 5. For example, the optimal image settings 502 to 504 may further include a video type, a frame rate, and an encoding method.

The description returns to FIGS. 4A to 4C. If a certain setting menu in the menu list 401 is selected by the user, the system control unit 203 of the information processing apparatus 200 executes the following process. That is, the system control unit 203 references the setting file 500 and identifies an optimal image setting associated with a setting process (any of the setting of a privacy mask, the setting of the video analysis process, and the setting of a clipping range) corresponding to the selected setting menu. For example, if the “setting menu (3)” 404 is selected by the user, the system control unit 203 identifies the optimal image setting 504 of the “setting menu (3)” 404. Then, based on the optimal image setting 504, the system control unit 203 generates a control command to transmit a clipped image in a currently set clipping range from the imaging apparatus 100 to the information processing apparatus 200 on the stream ‘3’ and transmits the control command to the imaging apparatus 100. According to the transmitted control command, the imaging apparatus 100 generates a clipped image by clipping a currently set clipping range from a captured image and distributes the clipped image on the stream ‘3’ to the information processing apparatus 200.

Further, the setting processes on the respective setting screens in FIGS. 4A to 4C are specifically described. First, the setting screen 400a corresponding to the setting of a privacy mask illustrated in FIG. 4A is described. In the image display area 405a on the setting screen 400a corresponding to the setting of a privacy mask, an image transmitted from the imaging apparatus 100 and captured at the maximum angle of view is displayed. The setting area 406a on the setting screen 400a also includes the following buttons.

That is, the setting area 406a includes an “add” button 408 for newly adding a privacy mask, a “delete” button 409 for deleting a privacy mask currently selected by the user, and a “save” button 410 for saving the current setting of a privacy mask. For example, when the “add” button 408 is pressed, a privacy mask 407 is added to the image displayed in the image display area 405a. According to a user operation for changing the position or the size of the privacy mask 407 on the image display area 405, the system control unit 203 can change the setting of the position or the size of the privacy mask 407. Further, for example, when the user selects the privacy mask 407 on the image displayed in the image display area 405a and then presses the “delete” button 409, the system control unit 203 can delete the setting of the privacy mask 407. According to a user operation for pressing the “save” button 410, the system control unit 203 also executes the following process. That is, the system control unit 203 stores the settings of the position and the size of a current privacy mask and also transmits a control command including information regarding the set position and size of the privacy mask to the imaging apparatus 100. From this point onward, for example, the imaging apparatus 100 superimposes the privacy mask on a captured image (or a clipped image) at the position set by the user and transmits an image obtained by superimposing the privacy mask to an external apparatus.

Next, the setting screen 400b corresponding to the setting of the video analysis process illustrated in FIG. 4B is described. In the image display area 405b on the setting screen 400b, a clipped image generated in the clipping process by the imaging apparatus 100 and transmitted from the imaging apparatus 100 is displayed.

The setting area 406b on the setting screen 400b also includes the setting of the maximum size of a person as a detection target of person detection that is the video analysis process (a maximum size setting 411) and the setting of the minimum size of the person as the detection target (a minimum size setting 412). The setting area 406b also includes a “save” button 413 for saving the settings (the maximum size setting 411 and the minimum size setting 412) regarding the video analysis process currently specified by the user.

Next, the setting screen 400c corresponding to the setting of a clipping range illustrated in FIG. 4C is described. In the image display area 405c on the setting screen 400c illustrated in FIG. 4C, a clipped image generated in the clipping process by the imaging apparatus 100 and transmitted from the imaging apparatus 100 is displayed. The setting area 406c on the setting screen 400c also includes position change buttons 414 for changing the position of the clipping range, a telephoto button 415 for reducing the size of the clipping range, and a wide-angle button 416 for increasing the size of the clipping range. According to a user operation for pressing at least any of the position change buttons 414, the telephoto button 415, and the wide-angle button 416, the system control unit 203 generates a control command to change the clipping range and transmits the control command to the imaging apparatus 100. Based on the control command, the imaging apparatus 100 identifies the changed clipping range, generates a clipped image in the clipping range, and transmits the clipped image to the information processing apparatus 200. The transmitted clipped image is displayed in the image display area 405c. Thus, according to a user operation for pressing at least any of the position change buttons 414, the telephoto button 415, and the wide-angle button 416, the image (the clipped image) displayed in the image display area 405c is also dynamically changed. If a cancel button 417 is pressed, the setting of the clipping range currently made by the user is cancelled. If a “save” button 418 is pressed, the setting of the clipping range currently made by the user is saved and applied.

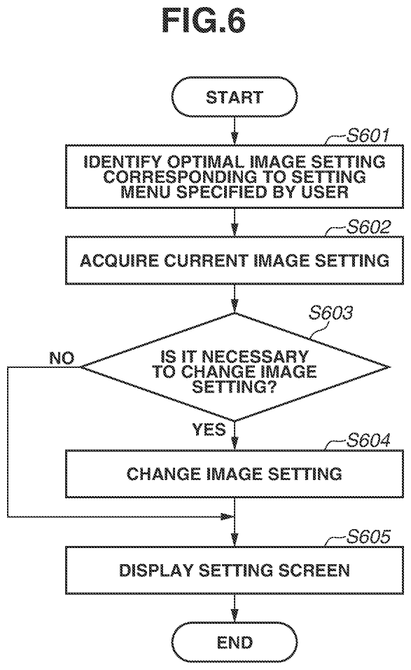

With reference to a flowchart illustrated in FIG. 6, information processing of the information processing apparatus 200 according to the present exemplary embodiment is described. For example, the processing of the flowchart illustrated in FIG. 6 is executed by the functional blocks of the information processing apparatus 200 illustrated in FIG. 3 that are achieved by the CPU 800 of the information processing apparatus 200 executing a computer program stored in the ROM 820 of the information processing apparatus 200.

First, in step S601, the system control unit 203 identifies information regarding an optimal image setting corresponding to a setting menu specified by the user. For example, the system control unit 203 references the setting file 500 held in advance and identifies an optimal image setting associated with the selected setting menu. For example, a case is assumed where the “setting menu (1)” 402 is selected by the user. In this case, the system control unit 203 references the setting file 500 and identifies the optimal image setting 502 corresponding to the “setting menu (1)” 402.

Next, in step S602, the system control unit 203 acquires the current image setting of an image currently transmitted from the imaging apparatus 100. For example, the system control unit 203 acquires information identifying the stream on which an image (a distributed image) currently transmitted from the imaging apparatus 100 or information regarding a clipping range in a case where the image is a clipped image.

Next, in step S603, the system control unit 203 compares the optimal image setting identified in step S601 and the current image setting acquired in step S602 and determines whether it is necessary to change the image setting. For example, a case is assumed where the optimal image setting identified in step S601 is the optimal image setting 502. In this case, if the imaging apparatus 100 is set to the maximum angle of view as the current image setting, then in step S603, the system control unit 203 determines that it is not necessary to change the image setting (No in step S603) because the optimal image setting 502 and the current image setting are the same as each other. If it is determined that it is not necessary to change the image setting (No in step S603), the processing proceeds to step S605. On the other hand, a case is assumed where a partial area of the image captured by the imaging apparatus 100 is set as a clipping range as the current image setting. In this case, since the optimal image setting 502 and the current image setting are different from each other, then in step S603, the system control unit 203 determines that it is necessary to change the image setting (Yes in step S603). If it is determined that it is necessary to change the image setting (Yes in step S603), the processing proceeds to step S604.

In step S604, the system control unit 203 generates a control command to obtain the optimal image setting identified in step S601 (i.e., the optimal image setting associated with the setting menu currently specified by the user) and transmits the control command to the imaging apparatus 100, thereby changing the image setting of the imaging apparatus 100. For example, a case is assumed where the optimal image setting identified in step S601 is the optimal image setting 502. In this case, based on the optimal image setting 502, the system control unit 203 generates a control command to transmit an image captured at the maximum angle of view from the imaging apparatus 100 to the information processing apparatus 200 on the stream ‘1’ and transmits the control command to the imaging apparatus 100. According to the transmitted control command, the imaging apparatus 100 captures an image at the maximum angle of view and distributes data on the image to the information processing apparatus 200 on the stream ‘1’.

In step S605, the display control unit 201 displays a setting screen corresponding to the currently specified setting menu on the display 210. At this time, the image transmitted from the imaging apparatus 100 is displayed on the setting screen.

As described above, according to a setting menu selected by the user, the information processing apparatus 200 displays an image suitable for the type of a setting process on a setting screen to be displayed. This can prevent an operation for displaying an image suitable for a certain setting process from being troublesome.

In a second exemplary embodiment, information regarding a setting menu specified by the user on a setting screen displayed by the information processing apparatus 200 is transmitted to the imaging apparatus 100, and the imaging apparatus 100 generates an image suitable for the setting menu and transmits the image to the information processing apparatus 200. The differences from the first exemplary embodiment are mainly described, and components and processes similar or equivalent to those in the first exemplary embodiment are designated by the same numerals and signs, and are not redundantly described.

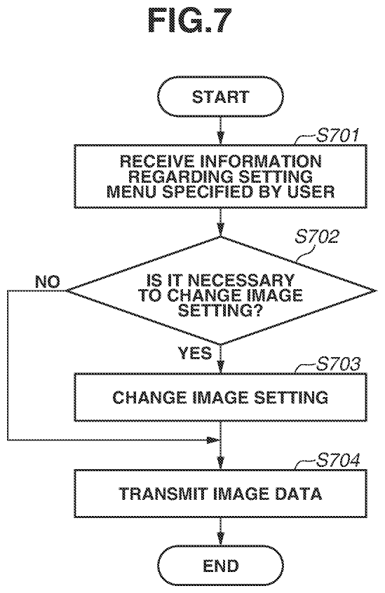

With reference to a flowchart illustrated in FIG. 7, processing of the imaging apparatus 100 according to the present exemplary embodiment is described below. For example, the processing of the flowchart illustrated in FIG. 7 is executed by the functional blocks of the imaging apparatus 100 illustrated in FIG. 3 that are achieved by the CPU 800 of the imaging apparatus 100 executing a computer program stored in the ROM 820 of the imaging apparatus 100.

First, in step S701, the system control unit 113 of the imaging apparatus 100 receives information transmitted from the information processing apparatus 200 regarding a setting menu specified by the user on a setting screen.

Next, in step S702, the system control unit 113 references the setting file 500 stored in the storage unit 115, identifies an optimal image setting associated with the currently specified setting menu, and based on the identified optimal image setting, determines whether it is necessary to change the current image setting. For example, a case is assumed where the setting menu corresponding to the information received in step S701 is the “setting menu (1)” 402. In this case, the system control unit 113 references the setting file 500 and identifies the optimal image setting 502 as the optimal image setting. If the imaging apparatus 100 is set to the maximum angle of view as the current image setting, then in step S702, the system control unit 113 determines that it is not necessary to change the image setting (No in step S703) because the optimal image setting 502 and the current image setting are the same as each other. If it is determined that it is not necessary to change the image setting (No in step S703), the processing proceeds to step S704. On the other hand, a case is assumed where a partial area of an image captured by the imaging apparatus 100 is set as a clipping range as the current image setting. In this case, in step S702, since the optimal image setting 502 and the current image setting are different from each other, the system control unit 113 determines that it is necessary to change the image setting (Yes in step S702). If it is determined that it is necessary to change the image setting (Yes in step S702), the processing proceeds to step S703.

In step S703, the system control unit 113 changes the image setting to obtain the optimal image setting corresponding to the currently specified setting menu. For example, a case is assumed where the setting menu corresponding to the information received in step S701 is the “setting menu (1)” 402. In this case, in step S703, to obtain the optimal image setting 502, the system control unit 113 controls the zoom magnification to reach the wide-angle end so that the imaging apparatus 100 is at the maximum angle of view.

In step S704, the system control unit 113 transmits captured image data to the information processing apparatus 200 via the communication unit 116. For example, a case is assumed where the setting menu corresponding to the information received in step S701 is the “setting menu (1)” 402. In this case, the system control unit 113 transmits image data on an image captured at the maximum angle of view to the information processing apparatus 200 on the stream ‘1’.

As described above, the imaging apparatus 100 according to the present exemplary embodiment generates an image suitable for a setting menu selected by the user and transmits the image to the information processing apparatus 200. This can prevent an operation for displaying an image suitable for a certain setting process from being troublesome.

### Other Exemplary Embodiments

Next, with reference to FIG. 8, the hardware configuration of the information processing apparatus 200 is described. Although the hardware configuration of the information processing apparatus 200 is described below, the imaging apparatus 100 is also achieved by a similar hardware configuration.

The information processing apparatus 200 according to the present exemplary embodiment includes the CPU 800, a random-access memory (RAM) 810, the ROM 820, a hard disk drive (HDD) 830, and the I/F 840.

The CPU 800 is a central processing unit that performs overall control of the information processing apparatus 200. The RAM 810 temporarily stores a computer program executed by the CPU 800. The RAM 810 provides a work area used to execute processing by the CPU 800. For example, the RAM 810 functions as a frame memory or functions as a buffer memory.

The ROM 820 stores a program for the CPU 800 to control the information processing apparatus 200. The HDD 830 is a storage device that records image data. The OF 840 communicates with an external apparatus according to the Transmission Control Protocol/Internet Protocol (TCP/IP) or the Hypertext Transfer Protocol (HTTP) via the network 300.

Although the example where the CPU 800 executes processing is described in the above exemplary embodiments, at least a part of the processing of the CPU 800 may be performed by dedicated hardware. For example, the process of reading a program code from the ROM 820 and loading the program code into the RAM 810 may be executed by direct memory access (DMA) that functions as a transfer apparatus.

Embodiments of the present disclosure can be achieved also by the process of causing one or more processors to read and execute a program for achieving one or more functions of the above exemplary embodiments. The program may be supplied to a system or an apparatus including the one or more processors via a network or a storage medium.

Embodiments of the present disclosure can be achieved also by a circuit (e.g., an application-specific integrated circuit (ASIC)) for achieving the one or more functions of the above exemplary embodiments. The components of the information processing apparatus 200 may be achieved by the hardware illustrated in FIG. 8, or can also be achieved by software.

Another apparatus may have the one or more functions of the information processing apparatus 200 according to each of the above exemplary embodiments. For example, the imaging apparatus 100 may have the one or more functions of the information processing apparatus 200 according to each of the exemplary embodiments. The above exemplary embodiments may be carried out by combining the above exemplary embodiments, such as optionally combining the above exemplary embodiments.

While embodiments of the present disclosure have been described, the above exemplary embodiments merely illustrate specific examples, and the technical scope of the present disclosure should not be interpreted in a limited manner based on these exemplary embodiments. That is, embodiments of the present disclosure can be carried out in various ways without departing from the technical idea or the main feature of the present disclosure. For example, the combinations of the exemplary embodiments are also included in the disclosed content of the specification.

According to the above exemplary embodiments, it is possible to prevent an operation for displaying an image suitable for a setting process to be performed on a setting screen from being troublesome.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-206194, filed Dec. 20, 2021, which is hereby incorporated by reference herein in its entirety.

What is claimed is:

1. An information processing apparatus comprising:
a computer executing instructions which, when executed by the computer, cause the information processing apparatus to:
acquire an image transmitted from an imaging apparatus;
cause a display to display the image and setting menus of a plurality of setting processes of different types; and
identify, in a case where a certain setting menu is selected from among the setting menus of the plurality of setting processes, an image setting corresponding to the certain setting menu based on respective image settings associated with the setting menus of the plurality of setting processes,
wherein a control command to cause an image setting of the imaging apparatus to match the identified image setting is generated and the control command is transmitted to the imaging apparatus.

2. The information processing apparatus according to claim 1, wherein the setting menus of the plurality of setting processes include a setting menu for setting a clipping range.

3. The information processing apparatus according to claim 1, wherein the setting menus of the plurality of setting processes include a setting menu for setting a privacy mask.

4. An imaging apparatus comprising:
a computer executing instructions which, when executed by the computer, cause the imaging apparatus to:
receive information regarding a setting menu currently specified among setting menus of a plurality of setting process of different types;
identify, based on respective image settings associated with the setting menus of the plurality of setting processes, an image setting corresponding to the setting menu corresponding to the received information;
generate an image based on the identified image setting; and
transmit the image to an information processing apparatus.

5. The imaging apparatus according to claim 4, wherein the setting menus of the plurality of setting processes include a setting menu for setting a clipping range.

6. The imaging apparatus according to claim 4, wherein the setting menus of the plurality of setting processes include a setting menu for setting a privacy mask.

7. An information processing method comprising:
acquiring an image transmitted from an imaging apparatus;
causing a display to display setting menus of a plurality of setting processes of different types and the image on; and
in a case where a certain setting menu is selected from among the setting menus of the plurality of setting processes, identifying an image setting corresponding to the certain setting menu based on respective image settings associated with the setting menus of the plurality of setting processes,
wherein a control command to cause an image setting of the imaging apparatus to match the identified image setting is generated and transmitted to the imaging apparatus.

8. A control method for controlling an imaging apparatus, the control method comprising:
capturing an image;
receiving information regarding a setting menu currently specified among setting menus of a plurality of setting process of different types; and
based on respective image settings associated with the setting menus of the plurality of setting processes, identifying an image setting corresponding to the setting menu corresponding to the received information,
wherein an image based on the identified image setting is generated and transmitted to an information processing apparatus.

9. A non-transitory computer-readable medium storing a computer-executable program for causing a computer to perform a method, the method comprising:
acquiring an image transmitted from an imaging apparatus;
causing a display to display setting menus of a plurality of setting processes of different types and the image; and
in a case where a certain setting menu is selected from among the setting menus of the plurality of setting processes, identifying an image setting corresponding to the certain setting menu based on respective image settings associated with the setting menus of the plurality of setting processes,
wherein a control command to cause an image setting of the imaging apparatus to match the identified image setting is generated and transmitted to the imaging apparatus.

10. A non-transitory computer readable medium storing a computer-executable program for causing a computer to perform a method, the method comprising:
capturing an image;
receiving information regarding a setting menu currently specified among setting menus of a plurality of setting process of different types; and
based on respective image settings associated with the setting menus of the plurality of setting processes, identifying an image setting corresponding to the setting menu corresponding to the received information,
wherein an image based on the identified image setting is generated and transmitted to an information processing apparatus.
